(19) United States
(12) Patent Application Publication
(10) Pub. No.: US 2002/0136883 A1
(43) Pub. Date: Sep. 26, 2002

(54) Air filtering filling material

(76) Inventors: Rubin S. Rochlin, Mercer Island, WA (US); Scott Karl Rochlin, Bellevue, WA (US)

Correspondence Address: Scott Rochlin, 126 107th Ave SE #15, Bellevue, WA, 98004, US

(21) Appl. No.: 10/015,452

(22) Filed: Dec. 11, 2001

Related U.S. Application Data
(60) Provisional application No. 60/254,522, filed on Dec. 11, 2000.

(51) Int. Cl. B32B 3/26

(52) U.S. Cl. 428/304.4

(57) ABSTRACT

A “flexible filtering filling material”, of pieces that are 100% open cell reticulated polyurethane foam. The pieces filter out the damp warm condition within the filling, haltering the proliferation of microorganisms, giving the product a more sanitary and longer life.

### CROSS REFERENCES TO RELATED APPLICATIONS

Patent applications: Provisional application No. 60/254,522

### STATEMENT OF FEDERALLY SPONSORED RESEARCH/DEVELOPMENT

Not applicable

### REFERENCE TO A MICROFICHE APPENDIX

Not applicable

### BACKGROUND OF THE INVENTION

The present invention pertains generally to a filling material that supports and gives comfort to the human body while allowing the warmth and moisture to freely filter out.

In the known prior art of various types of pillows, mattress pads, outer garments, comforters, etc., for supporting and giving comfort to the human body, the filling materials used in these products (particularly down, feathers, synthetic fibers and regular polyurethane foam) have certain disadvantages. They absorb moisture and warmth from the human body without a means for the damp warm condition to readily dissipate. This condition provides an unsatisfactory environment, which will proliferate the growth of mites and bacteria. The same pillow used by various persons in hotels, hospitals, or airplanes could become unsanitary in short order.

Mites and bacteria found in the filling material of bedding products, is an industry problem. Manufactures add anti-bacterial chemicals to the filling or are covering the filling, such as pillows, with mite and bacteria resistant covers as the solution. While these solutions may somewhat help, scientists claim the anti-bacterial chemicals form more resistant microorganisms.

Another problem of filling materials is the difficulty of a thorough washing. Some filling materials cannot be washed thoroughly. Down for example (to be thoroughly sanitized) should be commercially cleaned, which can be costly.

### BRIEF SUMMARY OF THE INVENTION

The present invention is a filling material for pillows, pads, outer garments, etc., that filters out the warmth and dampness, which is normally stagnant in filling materials.

The material used in the invention is of a 100% open cell reticulated polyurethane foam. The foam has no cell windows (walls), allowing unrestricted air passage. This foam filler material is formed of small random shaped pieces. The objective is to allow air to readily filter out the warm and damp condition. The small pieces provide the necessary flexibility for comfort, together with the required means of filtering. This filtering eliminates the warm and damp condition that is normally stagnant in the filling material. This new material becomes an “air filtering filling material” with applications for products using regular polyurethane foam, down, feather, polyester fibers, etc.

### BRIEF DESCRIPTION OF THE SEVERAL VIEWS OF THE DRAWING

Not applicable

### DETAILED DESCRIPTION OF THE INVENTION

The air filtering filling material of the invention, will be used for cushioning and comfort for the human body, while allowing warmth and dampness to freely filter out.

The material used for the invention is of a 100% open cell reticulated polyurethane foam. The foam resembles a high-rise building, with all walls, ceilings and floors removed and wrapped around the frame and reinforcing the frame. This foam, in its manufactured state, has 97% void space for high breathe ability, which allows for the free transferring of air.

The foam is cut into production sizes from bun stock by band saw, using scalloped or wire blades. These sizes will vary, based on the production method used. An example for grinding, these sizes would be approximately 6″×6″×6′. An example for cutting, these sizes would be in quarter inch sheets. Grinding is preferred for the firmer foam, while cutting with clicker machines is preferred for the softer foam. Machines for grindin or cutting the foam into the final small pieces are presently available in the foam industry. When grinding the foam, the preferred approximate final sizes will be from 0.25 to 0.5 inches in diameter. When cutting the foam, the dimensions can vary from 0.25×0.5× (up to) 2 inches, depending on the product. For example, furniture cushions with heavy textile covers, can use larger pieces without the obtrusiveness to the feel. We contemplate using the grinding method predominantly.

If the pieces are made too small, the foam can lose its open cell structure and may become ineffective for warmth and dampness to freely filter out. If the pieces were made too large (such as one inch cubes), they would be obtrusive to the touch when used for a bed pillow with a thin cover. Whatever the embodiment of the method chosen by those skilled in the art of this development, the inventions intended purpose is to create a filling material of small pieces (using 100% open cell reticulated polyurethane foam) that will filter out the warm and damp condition, while giving a product (such as pillows) a longer lasting sanitary life.

The small pieces of reticulated 100% open cell polyurethane foam will retain its resiliency longer than regular polyurethane foam or synthetic fibers. These small pieces become the necessary means for the flexibility required for comfort, together with the ability to filter out the warm and damp condition in the filling material.

1. What we claim as our invention: is a flexible air filtering filling material for pillows, pads, outer garments,
etc., that cushions and comforts the human body while filtering out the warm and damp condition.
The said filling claimed will freely transfer air, hampering the proliferation of microorganisms such as fungus, mites and molds.

2. The air filtering filling material claimed in claim one, are fabricated pieces ranging in sizes from approximately 0.25 to 0.5 inches diameter or approximately 0.25×0.5× (up to) 2 inches, from bun stock.
The filling claimed in claim one, to last longer without matting than regular open cell polyurethane foam in similar sizes.

3. The air filtering filling material claimed in claim one, wherein said pieces are fabricated from 100% open cell reticulated polyurethane foam.
